(19) United States
(12) Patent Application Publication
(10) Pub. No.: US 2025/0265121 A1
(43) Pub. Date: Aug. 21, 2025

(54) COMMAND EXCHANGE MECHANISM FOR OFFLOADING COMPUTATION

(71) Applicant: Samsung Electronics Co., Ltd., Suwon-si (KR)

(72) Inventors: Ilgu HONG, Santa Clara, CA (US); Young Tack JIN, San Jose, CA (US); Mukesh GARG, Stanford, CA (US); Changho CHOI, San Jose, CA (US)

(21) Appl. No.: 18/786,412

(22) Filed: Jul. 26, 2024

Related U.S. Application Data
(60) Provisional application No. 63/556,386, filed on Feb. 21, 2024.

(51) Int. Cl. G06F 9/50

(52) U.S. Cl. CPC G06F 9/5016; G06F 9/5038

(57) ABSTRACT

A device is disclosed. A memory may store information relating to a request. A processor may process a data based at least in part on the information relating to the request. The data may be stored on a storage device. A host processor may store the information relating to the request into the memory.

### RELATED APPLICATION DATA

This application claims the benefit of U.S. Provisional Patent Application Ser. No. 63/556,386, filed Feb. 21, 2024, which is incorporated by reference herein for all purposes.

### FIELD

The disclosure relates generally to computation, and more particularly to offloading computation using CXL memory.

### BACKGROUND

Storage devices are beginning to support near-data processing. Storage devices may themselves include processors, or may be associated with a near-data processor. Commands may be sent to the processor to execute on data on the storage device.

A need remains to improve the efficiency of command offloading.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including an accelerator, according to embodiments of the disclosure.

FIG. 2 shows details of the machine of FIG. 1, according to embodiments of the disclosure.

FIG. 3A shows details of the accelerator of FIG. 1, according to some embodiments of the disclosure.

FIG. 3B shows details of the accelerator of FIG. 1, according to other embodiments of the disclosure.

FIG. 4 shows the host processor of FIG. 1 sending a request to the accelerator of FIG. 1, according to embodiments of the disclosure.

FIG. 5 shows the host processor of FIG. 1 accessing information about the storage device of FIG. 1 from the accelerator of FIG. 1, according to embodiments of the disclosure.

FIG. 6 shows a flowchart of an example procedure for the accelerator of FIG. 1 to execute a request from the host processor of FIG. 1, according to embodiments of the disclosure.

FIG. 7 shows a flowchart of an example procedure for the host processor of FIG. 1 to allocate the memory of FIGS. 3A-3B in the accelerator of FIG. 1, according to embodiments of the disclosure.

FIG. 8 shows a flowchart of an example procedure for the host processor of FIG. 1 to send a request to the accelerator of FIG. 1, according to embodiments of the disclosure.

FIG. 9 shows a flowchart of an example procedure for the accelerator of FIG. 1 to return a result of the request to the host processor of FIG. 1, according to embodiments of the disclosure.

FIG. 10 shows a flowchart of an example procedure for the accelerator of FIG. 1 to store information about the storage device of FIG. 1, according to embodiments of the disclosure.

FIG. 11 shows a flowchart of an example procedure for the host processor of FIG. 1 to retrieve information about the storage device of FIG. 1 from the accelerator of FIG. 1, according to embodiments of the disclosure.

FIG. 12 shows a flowchart of an example procedure for the host processor of FIG. 1 to send a request for information about the storage device of FIG. 1 to the accelerator of FIG. 1, according to embodiments of the disclosure.

FIG. 13 shows a flowchart of an example procedure for the host processor of FIG. 1 to allocate the memory of FIGS. 3A-3B in the accelerator of FIG. 1, according to embodiments of the disclosure.

### SUMMARY

An accelerator may include a memory to store information relating to a request and a processor process data based on the information relating to the request. The data may be stored on a storage device, and a host processor may store the information relating to the request in the memory of the accelerator.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

As storage devices continue to grow in capacity, the amount of data stored thereon increases as well. To process the data may involve moving large amounts of data from the storage device to main memory so that the host processor may process the data. Moving large amounts of data may take time and may require evicting other data from main memory to make room for the data to be processed.

To make things more efficient, near-data processing may be performed. Near-data processing may involve having the storage device include or be near another processor that may process the data directly from the storage device, rather than transferring the data into the main memory for the host processor to process the data. This other processor may be termed an accelerator, and the combination of the storage device and the accelerator may be termed a computational storage device. The use of an accelerator to perform near-data processing also has the added benefit of freeing the host processor to perform other functions.

In a similar manner, Artificial Intelligence (AI) model training may also involve large data sets and computations, such as matrix multiplication. The host processor may not be the most efficient processor to perform such computations on large data sets. To address these issues, the host processor may offload such computations to an AI accelerator. But offloading such processing may involve large data transfers between the host memory and the AI accelerator's memory and/or computation launching mechanism.

But issuing commands to the accelerator may involve various operations. Portions of main memory may be allocated and pinned (so that it may not be paged out of main memory) to store the submission and completion queues, and to store the payload of the command. The host processor may then ring the doorbell of the storage device to retrieve the command. The storage device may then perform a Direct Memory Address (DMA) transfer to read the command from the submission queue and to read the payload from main memory into the storage device. And when the command completes, the storage device may perform a DMA transfer into the completion queue (as well as any data returned to the host processor). DMA transfers may take a lot of time to complete, and therefore may slow down the overall operation.

Embodiments of the disclosure address these problems by using memory of the storage device to store both the submission and completion queues and for payload transfer. The device memory may be a memory accessible by the device driver executing on the host processor, and which might or might not be accessible to the host operating system. Commands issued to the device driver may then be translated into commands to read or write data into the device memory by the device driver, thereby effecting a transfer into the memory of the device without using DMA. Similarly, when the accelerator completes its processing, and data returned may be read out of the device memory by the device driver and returned to the host processor, again without a DMA transfer.

The device memory may support, for example, a Compute Express Link® (CXL®) type 2 device, so that the device driver may manage the memory of the device, but without exposing the device memory to user applications executing on the host processor. (Compute Express Link and CXL are registered trademarks in the United States of the Compute Express Link Consortium, Inc.)

In addition, the device memory may be used to effect transfers of information regarding the state of the device. This information may include both static and dynamic information. Static information may include, for example, data structures identifying the device and its supported functions. Dynamic information may include, for example, runtime statistic information and the results of commands executed by the device. By transferring such data using the device memory, the command set of the device may be reduced to eliminate commands used to transfer such information.

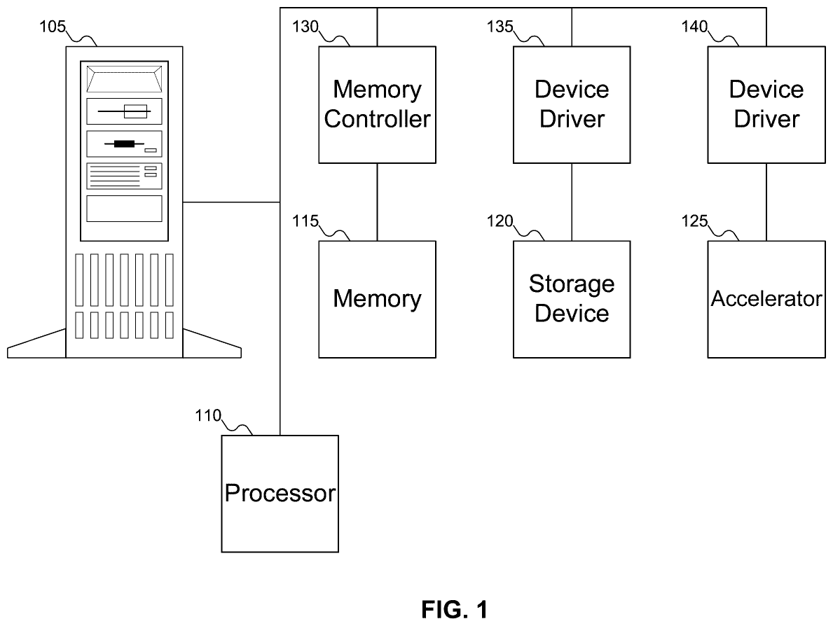

FIG. 1 shows a machine including an accelerator, according to embodiments of the disclosure. In FIG. 1, machine 105, which may also be termed a host or a system, may include processor 110, memory 115, storage device 120, and accelerator 125.

Processor 110, which may also be referred to as a host processor, to distinguish it from a processor in accelerator 125, may be any variety of processor. (Processor 110, along with the other components discussed below, are shown outside the machine for ease of illustration: embodiments of the disclosure may include these components within the machine.) While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 130. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. Whereas memory 115 may be used to store data that is considered “short-term”, storage device 120 may be used to store data that is considered “long-term”: that is, data that is expected to be retained for longer periods of time and that should be retained in a persistent manner, even if deliver of power to machine 105 should be interrupted. Storage device 120 may be accessed using device driver 135.

Storage device 120 may be associated with an accelerator (such as accelerator 125). The combination of storage device 120 and accelerator 125 may also be referred to as a computational storage device, computational storage unit, computational storage device, or computational device. Storage device 120 and accelerator 125 may be designed and manufactured as a single integrated unit, or accelerator 125 may be separate from storage device 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage device 120, accelerator 125, or a term referring to the combination of storage device 120 and accelerator 125 may be understood to refer to the devices either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or accelerator 125 might not be able to communicate with another storage device. For example, the storage device and the paired accelerator might be connected serially (in either order) to the fabric, enabling accelerator 125 to access information from the storage device in a manner another accelerator might not be able to achieve.

In some embodiments of the disclosure, accelerator 125 may be used for near-data processing. That is, accelerator 125 may be used to process data closer to storage device 120, to reduce or eliminate transfer of data from storage device 120 into memory 115. The use of accelerator 125 for near-data processing may also offload processing from processor 110, as accelerator 125 may perform such processing instead of processor 110. In other embodiments of the disclosure, accelerator 125 may be used for computational offloading, such as for an Artificial Intelligence (AI) accelerator. That is, accelerator 125 may be used to process large data sets for which processing by processor 110 may be expensive or inefficient.

Like processor 105, accelerator 125 may implement a Reduced Instruction Set Computer (RISC) architecture or a Complex Instruction Set Computer (CISC) architecture (among other possibilities), and may be implemented using a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

While FIG. 1 shows only one accelerator 125, embodiments of the disclosure may include any number (one or more) of accelerators 125. For example, two or more accelerators 125 may be configured to process data serially, so that the output of one accelerator 125 may be input to the next accelerator 125. Or, accelerators 125 may be configured to process data in parallel, with each accelerator 125 operating independently of the others. In either case, it may be more efficient for each or all accelerators 125 to end their processing at roughly the same time, in which case management of accelerators 125 may be beneficial.

Accelerator 125 may be accessed using device driver 140. In some embodiments of the disclosure, device drivers 125 and 140 may be separate device drivers; in other embodiments of the disclosure, device drivers 125 and 140 may be implemented as a single (combined) device driver. In embodiments of the disclosure including more than one accelerator 125, each accelerator 125 may be accessed using a separate device driver 140, or multiple accelerators 125 may be accessed using a common device driver 140. Embodiments of the disclosure may also mix various combinations: for example, one accelerator 125 might be accessed by its own device driver 140, whereas two other accelerators 125 might be accessed by a common device driver 140.

While FIG. 1 uses the generic term “storage device”, embodiments of the disclosure may include any storage device formats that may be associated with computational storage, examples of which may include hard disk drives and Solid State Drives (SSDs). Any reference to a specific type of storage device, such as an “SSD”, below should be understood to include such other embodiments of the disclosure.

Processor 105 and storage device 120 may communicate across a fabric (not shown in FIG. 1). This fabric may be any fabric along which information may be passed. Such fabrics may include fabrics that may be internal to machine 105, and which may use interfaces such as Peripheral Component Interconnect Express (PCIe), Serial AT Attachment (SATA), or Small Computer Systems Interface (SCSI), among others. Such fabrics may also include fabrics that may be external to machine 105, and which may use interfaces such as Ethernet, Infiniband, or Fibre Channel, among others. In addition, such fabrics may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, such fabrics may be thought of as encompassing both internal and external networking connections, over which commands may be sent, either directly or indirectly, to storage device 120. In embodiments of the disclosure where such fabrics support external networking connections, storage device 120 might be located external to machine 105, and storage device 120 might receive requests from a processor remote from machine 105.

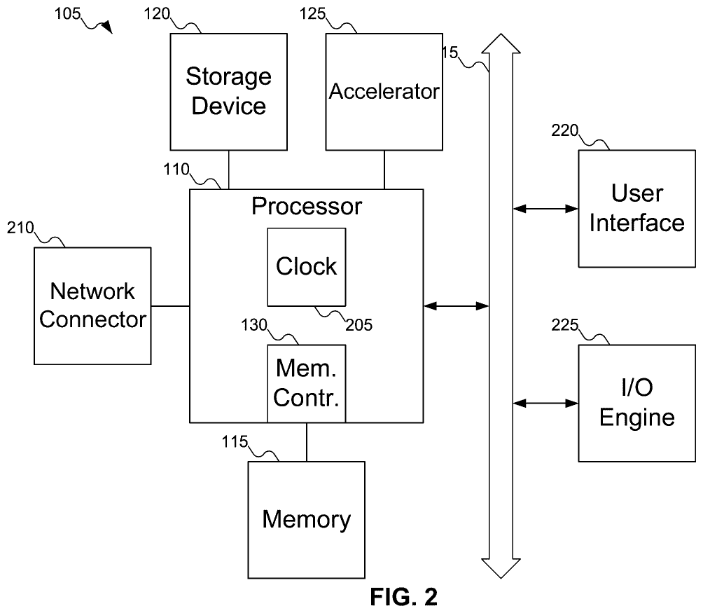

FIG. 2 shows details of the machine of FIG. 1, according to embodiments of the disclosure. In FIG. 2, typically, machine 105 includes one or more processors 110, which may include memory controllers 130 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, to accelerators 125, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

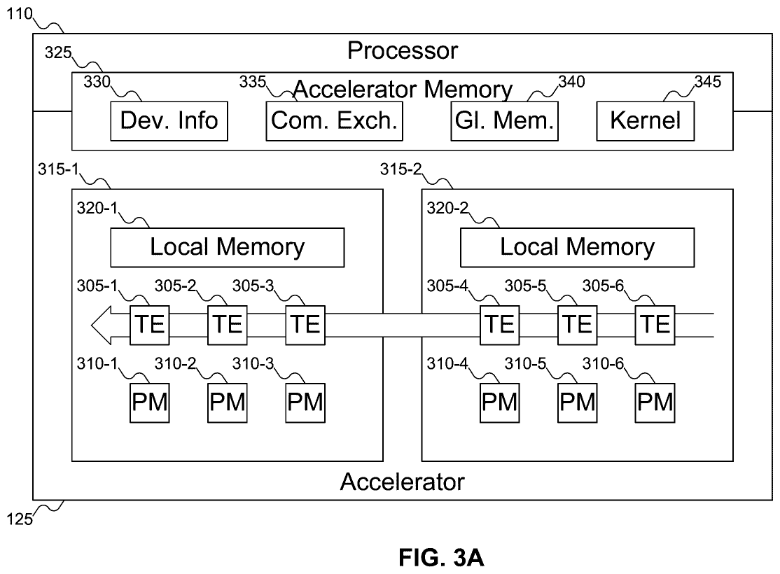

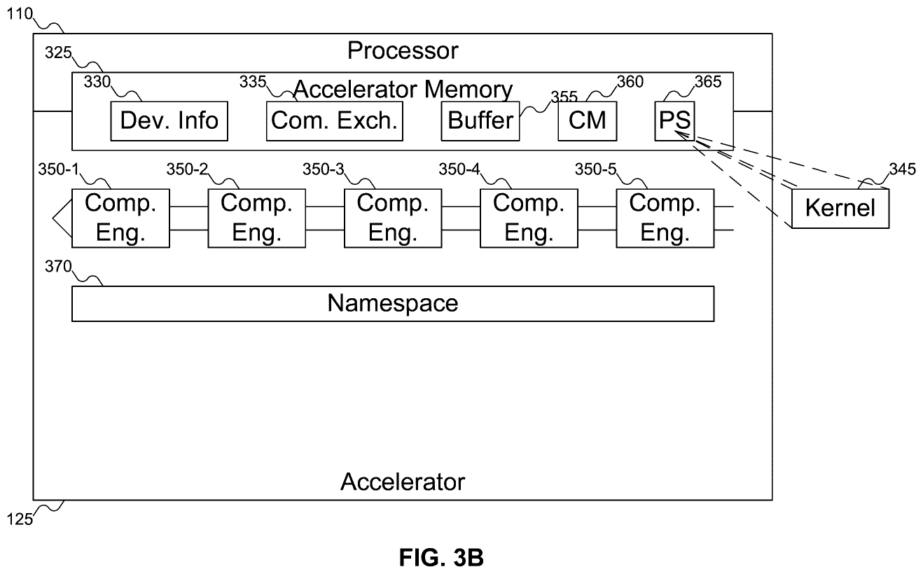

FIG. 3A shows details of accelerator 125 of FIG. 1, according to some embodiments of the disclosure. In FIG. 3A, accelerator 125 may be an AI or a Machine Learning (ML) accelerator. Accelerator 125 may include tensor engines 305-1 through 305-6, which may be referred to collectively as tensor engines 305. Tensor engines 305 are examples of processors that may be implemented as part of accelerator 125 (and, as noted above, which may be distinguished from processor 110). Each tensor engine 305 may have an associated private memory 310-1 through 310-6, which may be referred to collectively as private memories 310. Tensor engines 305 may be connected using any desired connection to support communication and data flow between tensor engines 305. For example, tensor engines 305 may be connected by a bus to enable communication and data flow, or a circuit may connect the output of one tensor engine 305 with the input of the next tensor engine 305 (with appropriate modifications for the first tensor engine (e.g., tensor engine 305-6) to receive the input data and for the last tensor engine (e.g., tensor engine 305-1) to send its output data onward). The connection between tensor engines 305 may also vary depending on the particular implementation of tensor engines 305. For example, if two tensor engines 305 that may operate sequentially are on different dies or different printed circuit boards, the connection between them may include appropriate interfaces to support such communication between their hardware.

Tensor engines 305 (and their associated private memories 310) may be organized into units, each of which may also share a local memory. Thus, for example, tensor engines 305-1, 305-2, and 305-3 may be grouped into unit 315-1 with local memory 320-1, and tensor engines 305-4, 305-5, and 305-6 may be grouped into unit 315-2 with local memory 320-2. Units 315-1 and 315-2 may be referred to collectively as units 315, and local memories 320-1 and 320-2 may be referred to collectively as local memories 320.

Units 315 may be implemented in any desired manner. For example, in some embodiments of the disclosure unit 315-1 might include a single die that includes local memory 320, tensor engines 305-1, 305-2, and 305-3, and private memories 310-1, 310-2, and 310-3. In other embodiments of the disclosure, unit 315-1 might include local memory 320, tensor engines 305-1, 305-2, and 305-3, and private memories 310-1, 310-2, and 310-3 as individual components that are interconnected, but are not necessarily all part of a single die. In yet other embodiments, unit 315-1 might be a logical collection of elements in accelerator 125 rather than a physically distinct group of elements (for example, a single circuit board might include local memories 320-1 and 320-2, tensor engines 305-1 through 305-6, and private memories 310-1 through 310-6). Embodiments of the disclosure may also mix different implementations of units 315: one unit 315 might be implemented using a single die whereas another unit 315 might be implemented as several components that are interconnected but not on a single die.

While FIG. 3A shows six tensor engines 305 organized into two units 315, embodiments of the disclosure may include any number of tensor engines 305, which may be organized into any number of units 315. Further, while FIG. 3A shows each unit 315 as including the same number of tensor engines 305, embodiments of the disclosure may group any number of tensor engines 305 into units 315, even grouping them unevenly. In addition, while each tensor engine 305 is described as having an associated private memory 310, embodiments of the disclosure may have tensor units 305 having any number (zero of more) of associated private memories 310, and each tensor engine 305 may have a different number of associated private memories 310. In a similar manner, while each unit 315 is described as having an associated local memory 320, embodiments of the disclosure may have units 315 having any number (zero of more) of local memories 320, and each unit 315 may have a different number of local memories 320.

Accelerator 125 may also include memory 325. While FIG. 3A shows memory 325 “spanning” processor 110 and accelerator 125, in terms of implementation memory 325 may be part of accelerator 125, but may be accessed by processor 110.

Memory 325 may be any desired form of memory, including flash memory, DRAM, SRAM, Persistent Random Access Memory, FRAM, or NVRAM, such as MRAM etc. In some embodiments of the disclosure, memory 325 may be a cache-coherent interconnect memory, such as a memory that supports the CXL protocol. In some embodiments of the disclosure, memory 325 may be a CXL type 2 memory, which may be accessed by processor 110 but may not be treated as an extension of memory 115 of FIG. 1. In such embodiments of the disclosure, for example, device driver 140 of FIG. 1 may be able to access memory 325, but user applications running on processor 110 may not be able to access memory 325.

Memory 325 may be used to store information to be exchanged between processor 110 and accelerator 125. For example, memory 325 may include information such as device information 330, command exchange mechanism 335, global memory 340, and kernel 345. Device information 330 may be used to store information about storage device 120 of FIG. 1 and accelerator 125. Device information 330 may include static information, such as an identifier of storage device 120 of FIG. 1, an identifier of accelerator 125 (if separate from storage device 120 of FIG. 1), information about storage device 120 of FIG. 1 and/or accelerator 125 such as their firmware revision numbers, the functions offered by storage device 120 of FIG. 1 and/or accelerator 125 such as built-in functions offered by storage device 120 of FIG. 1 and/or accelerator 125 and whether they offer the ability to download custom functions to be executed. Device information 330 may also include dynamic information, such as runtime statistics for storage device 120 of FIG. 1 and/or accelerator 125, such as information about how much data is being stored on storage device 120 of FIG. 1, the bandwidth usage of storage device 120 of FIG. 1 and/or accelerator 125, what functions have been executed (as well as their counts and how often they are executed), wear levels on storage device 120 of FIG. 1, and so on.

Command exchange mechanism 335 may be used to exchange commands (which may also be referred to as requests) between processor 110 and accelerator 125. Command exchange mechanism 335 may include, for example, submission queues and completion queues. Global memory 340 may be used to store additional information to be exchanged between processor 110 and accelerator 125. For example, global memory 340 may be used to store payloads of data to be exchanged between processor 110 and accelerator 125. An example of such a payload might include an indication of where the data to be processed by accelerator 125 using a particular function may be located on storage device 120. Processor 110 may establish a Physical Region Page (PRP) entry or a Scatter Gather List (SGL) entry that may identify the data to be processed using, for example, logical addresses associated with the data and used by processor 110. (Storage device 120 of FIG. 1 may include a translation layer that may be translate such logical addresses into physical addresses where the data is actually stored on storage device 120, which may enable storage device 120 of FIG. 1 to move data from one physical address to another without having to inform processor 120 of FIG. 1 every time data is relocated.) The PRP or SGL may then be treated as a payload for an associated request, and accelerator 125 may then use the payload to locate the specific data on storage device 120 of FIG. 1 to be processed.

Kernel 345 may be a kernel of code to be executed by accelerator 125. As noted above, in some embodiments of the disclosure, accelerator 125 may support executing custom functions downloaded from processor 110 to accelerator 125: kernel 345 may be such a custom function. Kernel 345 may be implemented in any desired manner. For example, kernel 345 might be a binary data representing object code to be executed by accelerator 125. Or, the functions might be implemented using a high-level programming language that is then compiled to produce kernel 345. Or, kernel 345 might be implemented using a high-level programming language that may then be compiled locally or interpreted by accelerator 125. Embodiments of the disclosure may also include other implementations for kernel 345. Execution of kernel 345 may then be implemented using tensor engines 305. Note that each tensor engine 305 may execute its own kernel 345 (or may implement a portion of kernel 345), and data may move between tensor engines 305 to achieve complete processing of the data.

In terms of operation, when processor 110 wants to issue a request to accelerator 125, processor 110 may build a packet containing the information appropriate to the request. This information may include, for example, the name of the function to be executed, a pointer to kernel 345 (if the function to be executed is not currently stored in accelerator 125), and information about where the data to be processed may be found on storage device 120 of FIG. 1. If the data to be processed is relatively small and/or stored together, processor 110 may simply include the information the packet; otherwise, processor 110 may construct a PRP or SGL entry, store that entry in global memory 340, and include a pointer to that entry in the packet.

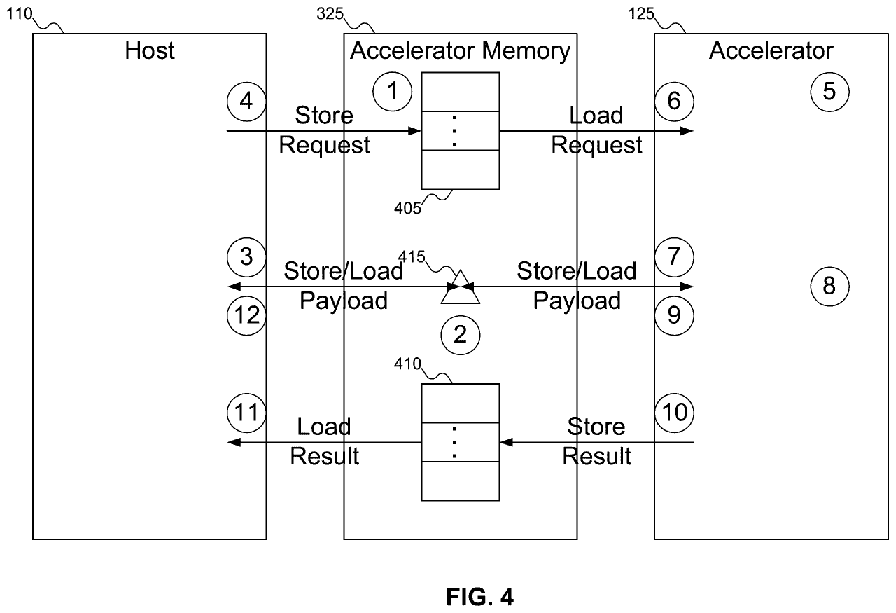

Once the packet has been assembled, processor 110 may store the request in command exchange mechanism 335 (as well as storing any appropriate payload in global memory 340). For example, processor 110 may store the packet in an entry in a submission queue (with an appropriate response placed in an entry in a completion queue, as discussed further with reference to FIG. 4 below). Accelerator 125 may then be notified that such a request has been issued by processor 110. For example, processor 110 may ring a doorbell (which may be thought of as a form of interrupt sent from processor 110 to accelerator 125, although a doorbell may also include some register to store data as well as a signal to accelerator 125) in accelerator 125 to alert accelerator 125 to the presence of the new request. Or, accelerator 125 may track pointers used to manage command exchange mechanism 335, and may determine that a new request has been added when processor 110 updates a pointer in command exchange mechanism 335. For example, if processor 110 places a new request in a submission queue in command exchange mechanism, processor 110 may update a tail pointer for the submission queue: accelerator 335 may determine that the tail pointer has changed and thus may conclude that a new request has been issued.

Accelerator 125 may then load the request from command exchange mechanism 335, as well as any payload from global memory 340 and kernel 345 as appropriate. Accelerator 125 may then execute the appropriate function on the data as identified in the request or the payload. Upon completing execution, accelerator 125 may store a result in a completion queue (or alternatively, in some command and status register) in command exchange mechanism 335, as well as any appropriate return payload in global memory 340. Accelerator 125 may then notify processor 110 that the request is complete. Accelerator 125 may notify processor 110 in any desired manner. For example, accelerator 125 may trigger an interrupt to processor 110 to alert processor 110 to the presence of the result. Alternatively, if accelerator 125 does not support a completion queue, processor 110 may poll a command and status register to determine when accelerator 125 has returned the result. Or, processor 110 may track pointers used to manage command exchange mechanism 335, and may determine that a new result has been added when accelerator 125 updates a pointer in command exchange mechanism 335. For example, if accelerator 125 places a new result in a completion queue in command exchange mechanism, accelerator 125 may update a tail pointer for the completion queue: processor 110 may determine that the tail pointer has changed and thus may conclude that a new result has been returned. Note, however, that processor 110 is waiting for the result to be placed in the completion queue, and therefore may be watching the completion queue for the result (unlike accelerator 125, which might not be watching the submission queue for a new request). Processor 110 may then retrieve the result from the completion queue in command exchange mechanism 335 (and any appropriate return payload from global memory 340).

It is worth noting that because memory 325 is accessible to both processor 110 and accelerator 125, both processor 110 and accelerator 125 may perform load and store operations to read and write data from memory 325. Load and store operations tend to be more efficient than Direct Memory Access (DMA) transfers, making the operation of processor 110 and accelerator 125 in embodiments of the disclosure more efficient than DMA transfers for requests and/or payloads between memory 115 of FIG. 1 and accelerator 125.

In addition, memory 115 of FIG. 1 may be used by processor 110, including any applications running on processor 110. Because memory tends to be expensive, it might not be possible for all data being used by processor 110 to be stored in memory 115 of FIG. 1 at any one time, and some data may be paged out of memory 115 of FIG. 1. To ensure that DMA transfers work as smoothly as possible, DMA transfers may require that the portion of memory 115 used to store the information to be transferred is pinned: that is, the memory is not subject to paging. Allocating and pinning memory to issue requests to accelerator 125 (and then unpinning and deallocating the memory afterward) may slow down the issuance of requests to accelerator 125. By having accelerator memory 325 accessible by processor 110 but not treated as an extension of memory 115 of FIG. 1, the use of memory 325 may be limited and the concern about memory 325 being subject to paging may be minimized or eliminated.

In some embodiments of the disclosure, processor 110 may directly access memory 325 as described above. In other embodiments of the disclosure, processor 110 itself might not be able to access memory 325, but device driver 140 of FIG. 1 may be able to access memory 325. Thus, when processor 110 performs some operation that involves memory 325, device driver 140 of FIG. 1 may receive the instruction and may perform that operation on behalf of processor 110. Again, by limiting what elements may access memory 325, the likelihood that memory 325 may be subject to paging may be minimized or eliminated.

FIG. 3B shows details of accelerator 125 of FIG. 1, according to other embodiments of the disclosure. In FIG. 3B, accelerator 125 may be an accelerator that is part of a computational storage unit. Accelerator 125 may include compute engines 350-1 through 350-5, which may be referred to collectively as compute engines 350. Compute engines 350 are other examples of processors that may be implemented as part of accelerator 125 (and, as noted above, which may be distinguished from processor 110). While not shown in FIG. 3B, each compute engine 350 may have access to a private memory or a shared local memory (similar to tensor engines 305 of FIG. 3A having access to private memories 310 and local memories 320).

While the implementation of accelerator 125 as shown in FIG. 3B differs from accelerator 125 as shown in FIG. 3A, the overall operation of accelerator 125 is the same. How memory 325 is used may be slightly different, however. Aside from device information 330 and command exchange mechanism 335, memory 325 may include shared input/output (I/O) buffer 355, compute memory 360, and program slot 365. Shared I/O buffer 355 may be used for additional data to be sent to or from accelerator 125, similar to how global memory 340 of FIG. 3A may be used to share other information (such as a payload). Compute memory 360 may be memory that may be used by compute engines 350, as an alternative to private memories 310 of FIG. 3A and/or local memories 320 of FIG. 3A. Finally, program slot 365 may be a specified location where kernel 345 may be loaded by processor 110. Note that while FIG. 3B shows only one program slot 365, embodiments of the disclosure may include any number (zero or more) of program slots 365, depending on the extent of custom function support accelerator 125 is designed to offer.

Finally, accelerator 125 may include namespace 370, which may be used to define scope for identifiers (such as logical addresses) used by processor 110.

Note that while FIGS. 3A-3B show alternative embodiments of the disclosure, embodiments of the disclosure may mix and match elements from both embodiments as desired. For example, the embodiment of accelerator 125 of FIG. 3A may include a namespace if desired.

FIG. 4 shows host processor 110 of FIG. 1 sending a request to accelerator 125 of FIG. 1, according to embodiments of the disclosure. In FIG. 4, processor 110 may establish submission queue 405 and completion queue 410 (operation circle 1). Submission queue 405 and completion queue 410 may be allocated from memory 325, or otherwise established in any desired manner. Processor 110 may then establish a portion of memory 325 for payload 415 (operation circle 2). Note that while establishing a portion of memory 325 for payload 415 might depend on the size of payload 415, submission queue 405 and completion queue 410 may be established once and then used as needed for communication between processor 110 and accelerator 125.

When processor 110 has a request to send to accelerator 125, processor 110 may store any information in payload 415 as appropriate to the request (operation circle 3). Processor 110 may also store the request in submission queue 405 (operation circle 4). Processor 110 may then ring the doorbell for submission queue 405 in accelerator 125 (operation circle 5).

Upon receiving the notification that there is a request in submission queue 405, accelerator 125 may load the request from submission queue 405 (operation circle 6). Accelerator 125 may also load any information from payload 415 as appropriate to the request (operation circle 7). Accelerator 125 may then execute the request (operation circle 8).

When accelerator 125 has completed processing the request, accelerator 125 may store any return information in payload 415 (operation circle 9). Accelerator 125 may store the result in completion queue 410 (operation circle 10).

Upon being notified that there is a result in completion queue 410, processor 110 may then load the result from completion queue 410 (operation circle 11). Processor 110 may also load any data from payload 415 (operation circle 12). At this point, the request has been completely handled and processor 110 has the result. Processor 110 may now deallocate payload 415, if appropriate.

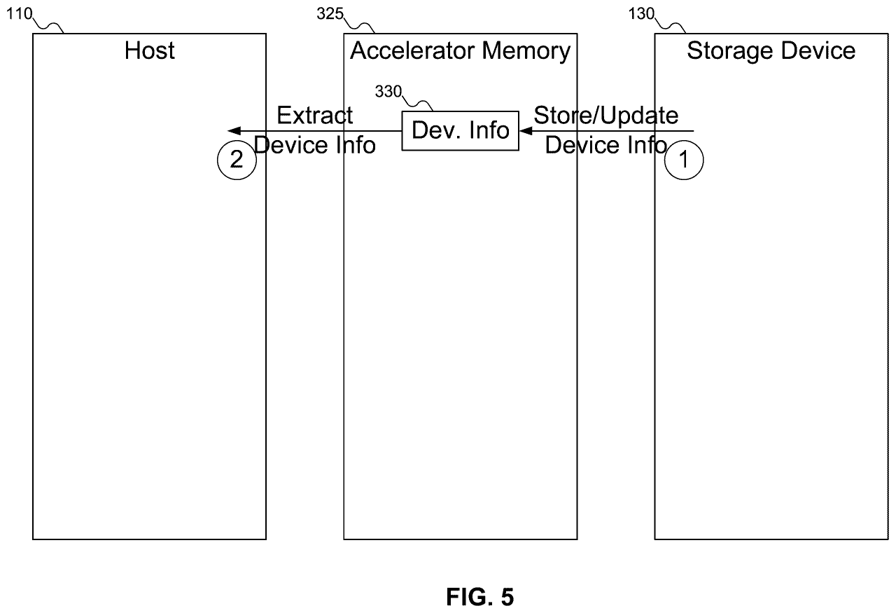

FIG. 5 shows host processor 110 of FIG. 1 accessing information about storage device 120 of FIG. 1 from accelerator 125 of FIG. 1, according to embodiments of the disclosure. In FIG. 5, as information becomes available, storage device 120 may store device information—either static or dynamic—in device information 330 in memory 325 (operation circle 1). Processor 110 may then load device information 330 from memory 325 and may extract whatever data is desired.

Note that storing the device information by storage device 120 may be performed more than once, particularly for dynamic information (which may change over time). Storing the device information by storage device 120 may also be performed as soon as the device information becomes available, or may be performed when processor 110 issues a request for such information. For example, the device identifier may be known when storage device 120 initially powers up, but might not be written to device information 330 in memory 325 until processor 110 requests such information.

Such techniques may also be used to determine information regarding accelerator 125 of FIG. 1.

By using memory 325 in this manner to exchange information between processor 110 and storage device 130, the command set used by storage device 120 may be reduced. For example, the NVMe command set includes various commands that may be used to identify storage device 120 and to determine the functions supported by storage device 120. By using memory 325 to provide a mechanism to exchange such information, the NVMe commands used to identify storage device 120 and/or to determine the supported functions—for example, identify, get log, and get feature—may be eliminated, reducing the number of commands that storage device 120 may need to recognize.

While FIG. 5 shows storage device 120 storing device information 330 in memory 325, embodiments of the disclosure may include accelerator 125 (not shown in FIG. 5) accessing the device information from storage device 120 and storing the device information in memory 325. In addition, embodiments of the disclosure may support acceleration of data stored on devices other than storage device 120. For example, accelerator 125 of FIG. 1 might be part of memory 115 of FIG. 1 (which may be considered a computational memory).

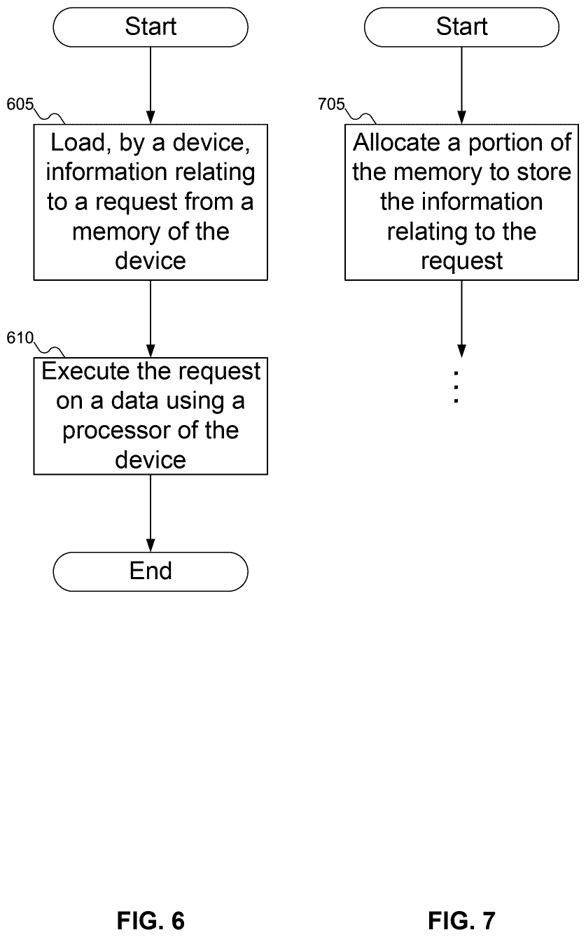

FIG. 6 shows a flowchart of an example procedure for accelerator 125 of FIG. 1 to execute a request from host processor 110 of FIG. 1, according to embodiments of the disclosure. In FIG. 6, at block 605, accelerator 125 of FIG. 1 may load information relating to a request from memory 325 of FIGS. 3A-3B. At block 610, accelerator 125 of FIG. 1 may then execute the request using a processor, such as tensor engines 305 of FIG. 3A or compute engines 350 of FIG. 3B.

FIG. 7 shows a flowchart of an example procedure for host processor 110 of FIG. 1 to allocate the memory of FIGS. 3A-3B in accelerator 125 of FIG. 1, according to embodiments of the disclosure. At block 705, host processor 110 of FIG. 1 (or device driver 140 of FIG. 1) may allocate a portion of memory 325 of FIGS. 3A-3B to store information relating to the request.

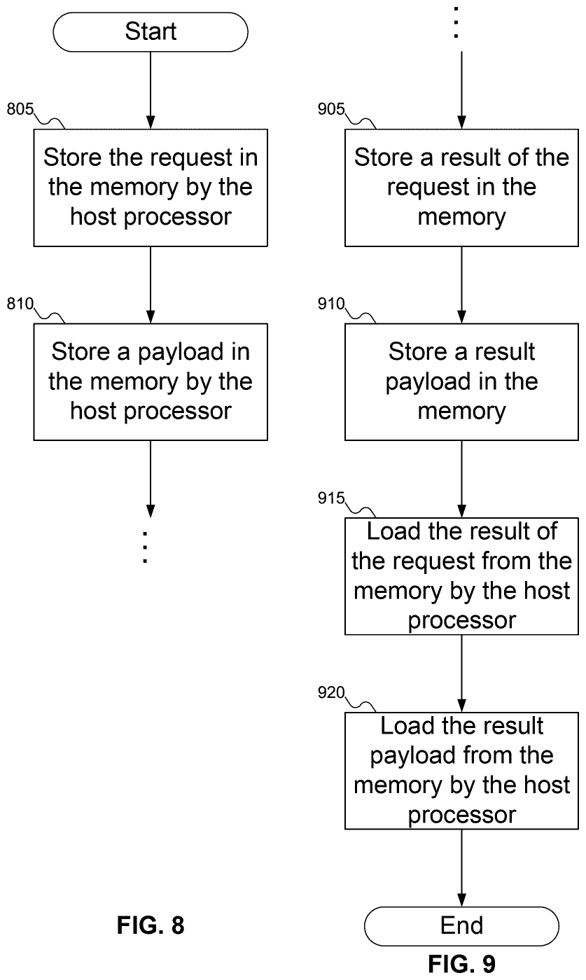

FIG. 8 shows a flowchart of an example procedure for host processor 110 of FIG. 1 to send a request to accelerator 125 of FIG. 1, according to embodiments of the disclosure. At block 805, host processor 110 of FIG. 1 (or device driver 140 of FIG. 1) may store the request in memory 325 of FIGS. 3A-3B: for example, in submission queue 405 of FIG. 4. At block 810, host processor 110 of FIG. 1 (or device driver 140 of FIG. 1) may store data in payload 415 of FIG. 4.

FIG. 9 shows a flowchart of an example procedure for accelerator 125 of FIG. 1 to return a result of the request to host processor 110 of FIG. 1, according to embodiments of the disclosure. In FIG. 9, at block 905, accelerator 125 of FIG. 1 may store a result in memory 325 of FIGS. 3A-3B: for example, in completion queue 410 of FIG. 4. At block 910, accelerator 125 of FIG. 1 may store result data in payload 415 of FIG. 4. At block 915, host processor 110 of FIG. 1 (or device driver 140 of FIG. 1) may load result from memory 325 of FIGS. 3A-3B. Finally, at block 920, host processor 110 of FIG. 1 (or device driver 140 of FIG. 1) may load result data from payload 415 of FIG. 4.

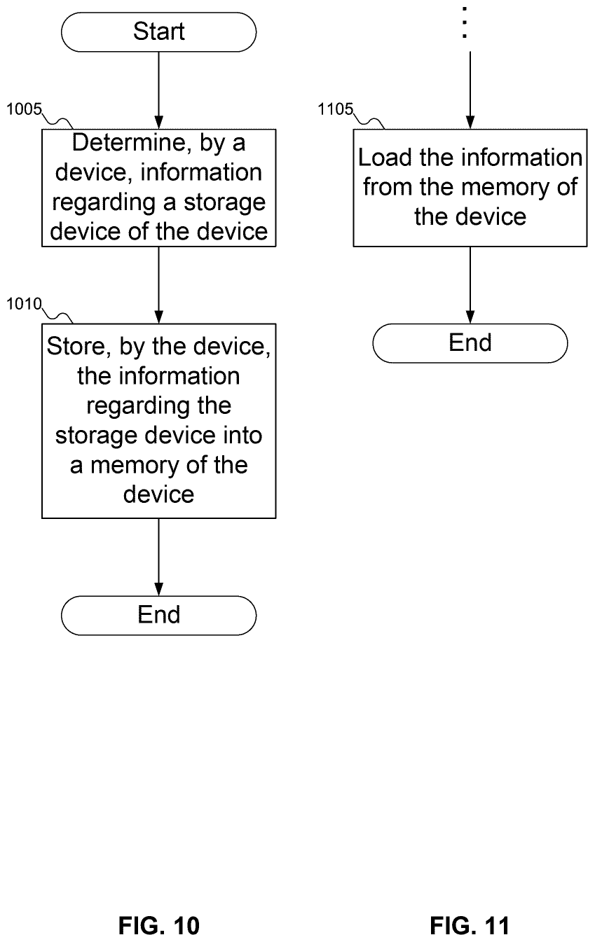

FIG. 10 shows a flowchart of an example procedure for accelerator 125 of FIG. 1 to store information about storage device 120 of FIG. 1, according to embodiments of the disclosure. At block 1005, accelerator 125 of FIG. 1 (or storage device 120 of FIG. 1) may determine information, which may be static information or dynamic information, about storage device 120 of FIG. 1. At block 1010, accelerator 125 of FIG. 1 (or storage device 120 of FIG. 1) may store the information about storage device 120 of FIG. 1 in memory 325 of FIGS. 3A-3B.

FIG. 11 shows a flowchart of an example procedure for host processor 110 of FIG. 1 to retrieve information about storage device 120 of FIG. 1 from accelerator 125 of FIG. 1, according to embodiments of the disclosure. At block 1105, host processor 110 of FIG. 1 (or device driver 140 of FIG. 1) may load the information about storage device 120 of FIG. 1 from memory 325 of FIGS. 3A-3B.

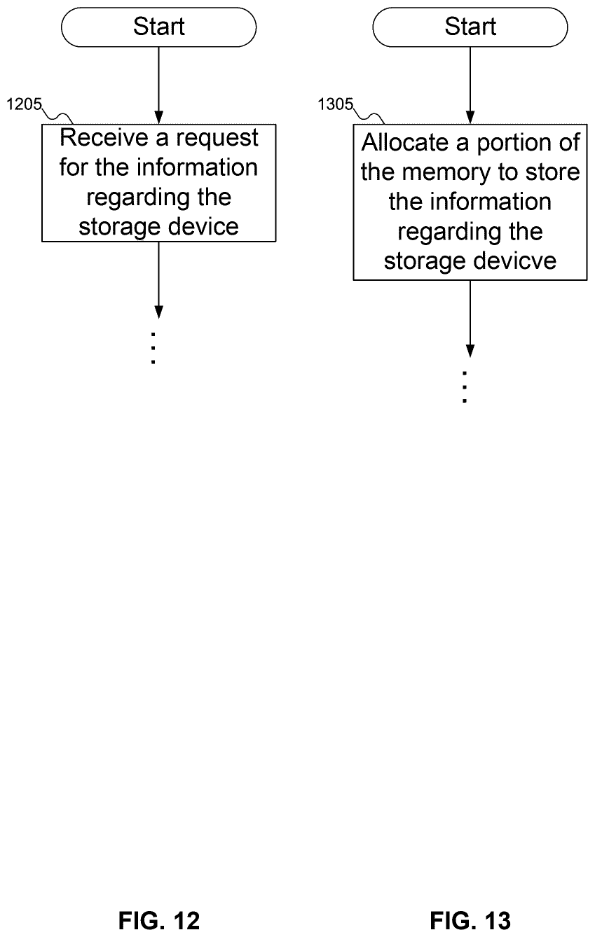

FIG. 12 shows a flowchart of an example procedure for host processor 110 of FIG. 1 to send a request for information about storage device 120 of FIG. 1 to accelerator 125 of FIG. 1, according to embodiments of the disclosure. At block 1205, accelerator 125 of FIG. 1 (or storage device 120 of FIG. 1) may receive a request from host processor 110 of FIG. 1 (or from device driver 140 of FIG. 1) for the information about storage device 120 of FIG. 1.

FIG. 13 shows a flowchart of an example procedure for host processor 110 of FIG. 1 to allocate the memory of FIGS. 3A-3B in accelerator 125 of FIG. 1, according to embodiments of the disclosure. In FIG. 13, at block 1305, host processor 110 of FIG. 1 (or device driver 140 of FIG. 1) may allocate a portion of memory 325 of FIGS. 3A-3B to store information regarding storage device 120 of FIG. 1.

In FIGS. 6-13, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may include a memory in an accelerator. The memory may be used to pass requests to the accelerator, or to request information about a storage device. By using the memory of the accelerator to exchange information about requests or about the storage device, fewer commands may be used, and Direct Memory Access (DMA) transfers may be minimized or eliminated, thereby providing a technical advantage.

Offloading computation may be used in various applications such as DataBase (DB) accelerator, Digital Signal Processing (DSP), and Artificial Intelligence (AI)/Machine Learning (ML) training and inferencing.

For example, an AI framework may use an AI accelerator to offload computation to reduce model training and inference time. A general AI accelerator may have a memory hierarchy. Global memory may be shared memory that is shared with local AI engines which may include multiple tensor engines and local memory. Local memory may be shared by tensor engines in the same AI engine. Each tensor engine may also have private memory that is only accessible by it.

Global memory may also be shared (accessible) by the host, and may be used for the input, output, and temporary place for the offload computation. In general, the host has responsibility to provide transparent data transfer for global memory, which is normally composed of memory pinning, mapping to Input-Output Memory Management Unit (IOMMU) address space, and Direct Memory Access (DMA) transfer.

The AI accelerator may also provide a mechanism to exchange command for loading and schedule kernel which is offloaded execution image.

As another example, a computational storage may use an embedded computation unit for accelerating data processing on the Non-Volatile Memory (NVM) namespace. In general, a computational storage may include a compute memory that is space for the input/output and temporary data, a compute engine that may be used to execute a kernel, and a program slot that may be used to save a downloaded kernel. The computational storage may also include an I/O memory buffer that may be used for data movement between the host and the NVM namespace.

Data transfer and command exchange between host and computational storage also requires a lot of host memory manipulation as we see in the AI accelerator example.

The command exchange mechanism of existing PCIe devices such as Non-Volatile Memory Express (NVMe) may include may host memory manipulations for DMA and data transfer through DMA between host and device. From the preparation step for communication to actual communication, executing a command on a computational storage may require a significant number of CPU cycles and DMA transfers even a single read/write operation.

### Communication Preparation Step

First, the host device drive may create command queues (submission/completion), which may be pinned on the host physical memory and also may be mapped to the IOMMU address space for DMA.

Second, the host device driver may create a DMA buffer pool. Each DMA buffer may be pinned and mapped to the IOMMU address space, like the command queues. DMA buffers may be used to save a Physical Region Page (PRP) list which is list of payload physical page address.es The max DMA buffer size in a Linux NVMe device driver is the Page Size (normally 4 KB). and it will cover 512 payload physical pages (each payload physical page using 8 B).

### Command Preparation Step

First, the host device driver may pin a payload buffer to a host physical address and get a mapped address in the IOMMU address space for each payload physical page, as the operating system (OS) may not guarantee the payload buffer is in a physically continuous memory space. The Linux NVMe driver may payload buffer split a 4 KB memory page and treat it as separate DMA items.

Second, the host device driver may get a DMA buffer and set a payload physical address list over there.

### Fetch Command and Payload

First, the device firmware may start processing a command block when a Submission Queue (SQ) Tail doorbell is triggered. The device firmware may fetch a command block to local memory through DMA and parse command block.

Second, if the command has a payload block, the device firmware may fetch a PRP list to local memory through DMA and parse and fetch each payload through DMA to local memory. Theoretically, in the worst case there may be 512 additional DMA operations for payload loading.

### Completion Step

The device firmware may send a completion block through DMA to the host.

TABLE 1
Command exchange overhead of NVMe device

| Stage | Memory manipulation/DMA |
|---|---|
| Initialization | Create pinned and mapped submission |
| | and completion queue |
| | Create DMA buffer pool |
| | (pinned and mapped DMA buffer) |
| Payload | Prepare Pinned and mapped pages |
| | of payload buffer and set it on DMA |
| | buffer (# pages in payload) |
| Dispatch | Fetch command block through DMA |
| command | |
| Read/Write | Fetch DMA buffer through DMA |
| payload | Transfer payload through DMA |
| | #DMA for payload is depend on payload |
| | size (4 KB page basic unit), max |
| | number of #DMA is will be restricted by |
| | entry count on DMA buffer (512 = 4 |
| | KB/8) |
| Completion | Transfer completion through DMA |

Table 1 summarizes memory manipulation overhead and DMA on NVMe command exchange mechanism.

With CXL memory, the memory space may be exposed to the host physical address space and enable the host to allow memory operations to access CXL memory. In this manner, memory manipulation on the host side and DMA operations for data transfer may be eliminated because CXL memory is already physically pinned and accessible though memory operation, such as load/store operations.

### Communication Preparation Step

First, the host device driver may reserve space on the CXL memory for command queues (submission and completion).

Second, the host device driver may allocate memory in the CXL memory for the payload buffer.

### Command Preparation Step

The application may write the payload data through a store memory operation and the host device driver may fill command block.

### Fetch Command and Payload

The device firmware may read a command block through a load memory operation.

The device firmware may parse and read the payload through a load memory operation (for read type operation). The device firmware may write the payload through a store memory operation (for write type operation).

### Completion Step

The device firmware may write a completion block through a store memory operation.

TABLE 2
Command exchange mechanism with CXL memory

| Stage | Memory manipulation/mem-op |
|---|---|
| Initialization | Allocate submission and completion |
| | queue on CXL memory |
| Payload | Allocate buffer on CXL memory |
| | Read/Write payload (load-store memory op) |
| Request | Write command (store memory op) |
| Dispatch | Read command block (load memory op) |
| command | |
| Read/Write | Fill payload (store memory op) or |
| payload | Read payload (load memory op) |
| | Not require explicit data transfer |
| Completion | Write completion (store memory op) |

Table 2 summarizes the command exchange mechanism with CXL memory.

First, the host device driver does not need to care about memory manipulation for DMA support.

Second, the command exchange mechanism may remove DMA data transfers as CXL memory support data transfers through memory operations (load/store) between the host and devices.

### Reduce Command Set

As CXL memory may be shared between the host and device, the command set that reports hardware/device static information or hardware/device runtime information may be reduced by reserving a portion of CXL memory for this purpose.

First, CXL memory space may be reserved for hardware/device static information and hardware/device runtime statistic information.

Second, the device firmware may set hardware/device static information during device initial time.

Third, the device firmware may update hardware/device statistic information periodically.

Fourth, the host device driver may retrieve hardware/device static information or hardware/device runtime statistic information when it processes hardware/device information request of application.

The hardware/device information retrieval commands (such as Identify, Get log, and Get feature command in NVMe) may be eliminated, and the device driver may handle such requests in the host device driver.

CXL memory may be used for:
1) Hardware/firmware information storage, which may include static or runtime information, and which may reduce and or remove existing command set.
2) Command exchange mechanism which may remove existing memory manipulation overhead in host.
3) Global shared memory over the CXL memory may replace DMA transfers as memory operations.
4) The host may implement resource management mechanism over the CXL memory space, such as memory allocation for computation and program slot management for the kernel.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:

Statement 1. An embodiment of the disclosure includes a device, comprising:
a memory to store information relating to a request; and
a processor to process a data based at least in part on the information relating to the request,
wherein the data is stored on a storage device; and
wherein a host processor is configured to store the information relating to the request into the memory.

Statement 2. An embodiment of the disclosure includes the device according to statement 1, wherein the memory includes a Compute Express Link (CXL) memory.

Statement 3. An embodiment of the disclosure includes the device according to statement 2, wherein the CXL memory includes a CXL type 2 memory.

Statement 4. An embodiment of the disclosure includes the device according to statement 1, wherein a device driver executing on the host processor is configured to store the information relating to the request into the memory.

Statement 5. An embodiment of the disclosure includes the device according to statement 1, wherein the processor is configured to load the information relating to the request from the memory.

Statement 6. An embodiment of the disclosure includes the device according to statement 5, wherein the processor is configured to load the information relating to the request from the memory without using a DMA transfer.

Statement 7. An embodiment of the disclosure includes the device according to statement 5, wherein the processor is configured to load the information relating to the request from the memory using a load request.

Statement 8. An embodiment of the disclosure includes the device according to statement 1, wherein the host processor is configured to store the information relating to the request into the memory without using a Direct Memory Address (DMA) transfer.

Statement 9. An embodiment of the disclosure includes the device according to statement 1, wherein the host processor is configured to store the information relating to the request into the memory using a store request.

Statement 10. An embodiment of the disclosure includes the device according to statement 1, wherein the memory is configured to store the information relating to the request without pinning a portion of the memory.

Statement 11. An embodiment of the disclosure includes the device according to statement 1, wherein the information relating to the request includes at least one of a submission queue, a completion queue, a packet structure including the request, or a payload structure.

Statement 12. An embodiment of the disclosure includes the device according to statement 11, wherein the information relating to the request further includes a kernel.

Statement 13. An embodiment of the disclosure includes the device according to statement 12, wherein the kernel includes a kernel binary.

Statement 14. An embodiment of the disclosure includes the device according to statement 13, wherein the host processor is configured to store the kernel binary in a program slot in the memory.

Statement 15. An embodiment of the disclosure includes the device according to statement 1, wherein the memory is configured to store a result of the request.

Statement 16. An embodiment of the disclosure includes the device according to statement 15, wherein the processor is configured to store the result of the request into the memory without using a Direct Memory Address (DMA) transfer.

Statement 17. An embodiment of the disclosure includes the device according to statement 15, wherein the processor is configured to store the result of the request into the memory using a store request.

Statement 18. An embodiment of the disclosure includes the device according to statement 15, wherein the host processor is configured to load the result of the request from the memory without using a DMA transfer.

Statement 19. An embodiment of the disclosure includes the device according to statement 15, wherein the host processor is configured to load the result of the request from the memory using a load request.

Statement 20. An embodiment of the disclosure includes the device according to statement 1, wherein the host processor is configured to allocate a portion of the memory to store the information relating to the request.

Statement 21. An embodiment of the disclosure includes the device according to statement 1, further comprising the storage device.

Statement 22. An embodiment of the disclosure includes a device, comprising:
a storage device; and
a memory to store information regarding the storage device; and
wherein the storage device is configured to store the information regarding the storage device into the memory.

Statement 23. An embodiment of the disclosure includes the device according to statement 22, wherein the memory includes a Compute Express Link (CXL) memory.

Statement 24. An embodiment of the disclosure includes the device according to statement 23, wherein the CXL memory includes a CXL type 2 memory.

Statement 25. An embodiment of the disclosure includes the device according to statement 22, wherein a device driver executing on the host processor is configured to load the information regarding the storage device from the memory.

Statement 26. An embodiment of the disclosure includes the device according to statement 22, wherein the device is configured to store the information regarding the storage device into the memory.

Statement 27. An embodiment of the disclosure includes the device according to statement 26, wherein the device is configured to store the information regarding the storage device into the memory without using a DMA transfer.

Statement 28. An embodiment of the disclosure includes the device according to statement 26, wherein the device is configured to store the information regarding the storage device into the memory using a load request.

Statement 29. An embodiment of the disclosure includes the device according to statement 22, wherein the host processor is configured to load the information regarding the storage device from the memory without using a Direct Memory Address (DMA) transfer.

Statement 30. An embodiment of the disclosure includes the device according to statement 22, wherein the host processor is configured to load the information regarding the storage device from the memory using a load request.

Statement 31. An embodiment of the disclosure includes the device according to statement 22, wherein the memory is configured to store the information regarding the storage device without pinning a portion of the memory.

Statement 32. An embodiment of the disclosure includes the device according to statement 22, wherein the information regarding the storage device includes at least one of a static information or a dynamic information.

Statement 33. An embodiment of the disclosure includes the device according to statement 32, wherein the static information includes at least one of a device identity information or a feature information.

Statement 34. An embodiment of the disclosure includes the device according to statement 32, wherein the dynamic information includes runtime statistic information.

Statement 35. An embodiment of the disclosure includes the device according to statement 22, wherein the host processor is configured to allocate a portion of the memory to store the information regarding the storage device.

Statement 36. An embodiment of the disclosure includes a method, comprising:
loading, by a device, information relating to a request from a memory of the device; and
executing the request on a data using a processor of the device,
wherein the data is stored on a storage device.

Statement 37. An embodiment of the disclosure includes the method according to statement 36, wherein the memory of the device includes a Compute Express Link (CXL) memory of the device.

Statement 38. An embodiment of the disclosure includes the method according to statement 37, wherein the CXL memory of the device includes a CXL type 2 memory of the device.

Statement 39. An embodiment of the disclosure includes the method according to statement 36, further comprising storing, by a host processor, the information relating to the request into the memory of the device.

Statement 40. An embodiment of the disclosure includes the method according to statement 39, wherein storing, by the host processor, the information relating to the request into the memory of the device includes storing, by a device driver executing on the host processor, the information relating to the request into the memory of the device.

Statement 41. An embodiment of the disclosure includes the method according to statement 39, wherein storing, by the host processor, the information relating to the request into the memory of the device includes storing, by the host processor, the information relating to the request into the memory of the device without using a Direct Memory Address (DMA) transfer.

Statement 42. An embodiment of the disclosure includes the method according to statement 39, wherein storing, by the host processor, the information relating to the request into the memory of the device includes storing, by the host processor, the information relating to the request into the memory of the device using a store request.

Statement 43. An embodiment of the disclosure includes the method according to statement 39, wherein storing, by the host processor, the information relating to the request into the memory of the device includes storing, by the host processor, the information relating to the request into the memory of the device without pinning a portion of the memory of the device.

Statement 44. An embodiment of the disclosure includes the method according to statement 36, wherein loading, by the device, the information relating to the request from the memory of the device includes loading, by the processor, the information relating to the request from the memory of the device.

Statement 45. An embodiment of the disclosure includes the method according to statement 44, wherein loading, by the processor, the information relating to the request from the memory of the device includes loading, by the processor, the information relating to the request from the memory of the device without using a DMA transfer.

Statement 46. An embodiment of the disclosure includes the method according to statement 44, wherein loading, by the processor, the information relating to the request from the memory of the device includes loading, by the processor, the information relating to the request from the memory of the device using a load request.

Statement 47. An embodiment of the disclosure includes the method according to statement 36, wherein the information relating to the request includes at least one of a submission queue, a completion queue, a packet structure including the request, or a payload structure.

Statement 48. An embodiment of the disclosure includes the method according to statement 47, wherein the information relating to the request further includes a kernel.

Statement 49. An embodiment of the disclosure includes the method according to statement 48, wherein the kernel includes a kernel binary.

Statement 50. An embodiment of the disclosure includes the method according to statement 49, further comprising storing, by a host processor, the kernel binary into a program slot in the memory of the device.

Statement 51. An embodiment of the disclosure includes the method according to statement 36, further comprising storing, by the device, a result of the request in the memory of the device.

Statement 52. An embodiment of the disclosure includes the method according to statement 51, wherein storing, by the device, the result of the request in the memory of the device includes storing, by the processor, the result of the request in the memory of the device.

Statement 53. An embodiment of the disclosure includes the method according to statement 52, wherein storing, by the processor, the result of the request in the memory of the device includes storing, by the processor, the result of the request in the memory of the device without using a Direct Memory Address (DMA) transfer.

Statement 54. An embodiment of the disclosure includes the method according to statement 52, wherein storing, by the processor, the result of the request in the memory of the device includes storing, by the processor, the result of the request in the memory of the device using a store request.

Statement 55. An embodiment of the disclosure includes the method according to statement 51, further comprising loading, by a host processor, the result of the request from the memory of the device.

Statement 56. An embodiment of the disclosure includes the method according to statement 55, wherein loading, by the host processor, the result of the request from the memory of the device includes loading, by the host processor, the result of the request from the memory of the device without using a DMA transfer.

Statement 57. An embodiment of the disclosure includes the method according to statement 55, wherein loading, by the host processor, the result of the request from the memory of the device includes loading, by the host processor, the result of the request from the memory of the device using a load request.

Statement 58. An embodiment of the disclosure includes the method according to statement 36, further comprising allocating, by a host processor, a portion of the memory of the device to store the information relating to the request.

Statement 59. An embodiment of the disclosure includes the method according to statement 36, wherein the device includes the storage device.

Statement 60. An embodiment of the disclosure includes a method, comprising:
determining, by a device, information regarding a storage device of the device; and
storing, by the device, the information regarding the storage device into a memory of the device.

Statement 61. An embodiment of the disclosure includes the method according to statement 60, wherein the memory of the device includes a Compute Express Link (CXL) memory of the device.

Statement 62. An embodiment of the disclosure includes the method according to statement 61, wherein the CXL memory of the device includes a CXL type 2 memory of the device.

Statement 63. An embodiment of the disclosure includes the method according to statement 60, wherein:
the method further comprises receiving, by the device, a request for the information regarding the storage device from a host processor; and
storing, by the device, the information regarding the storage device into a memory of the device includes storing, by the device, the information regarding the storage device into a memory of the device based at least part on the request for the information regarding the storage device received from the host processor.

Statement 64. An embodiment of the disclosure includes the method according to statement 60, wherein storing, by the device, the information regarding the storage device into the memory of the device includes storing, by the device, the information regarding the storage device into the memory of the device without using a DMA transfer.

Statement 65. An embodiment of the disclosure includes the method according to statement 60, wherein storing, by the device, the information regarding the storage device into the memory of the device includes storing, by the device, the information regarding the storage device into the memory of the device using a load request.

Statement 66. An embodiment of the disclosure includes the method according to statement 60, further comprising loading, by a host processor, the information regarding the storage device from the memory of the device.

Statement 67. An embodiment of the disclosure includes the method according to statement 66, wherein loading, by a host processor, the information regarding the storage device from the memory of the device includes loading, by a device driver executing on a host processor, the information regarding the storage device from the memory of the device.

Statement 68. An embodiment of the disclosure includes the method according to statement 66, wherein loading, by the host processor, the information regarding the storage device from the memory of the device includes loading, by the host processor, the information regarding the storage device from the memory of the device without using a Direct Memory Address (DMA) transfer.

Statement 69. An embodiment of the disclosure includes the method according to statement 66, wherein loading, by the host processor, the information regarding the storage device from the memory of the device includes loading, by the host processor, the information regarding the storage device from the memory of the device using a load request.

Statement 70. An embodiment of the disclosure includes the method according to statement 66, wherein loading, by the host processor, the information regarding the storage device from the memory of the device includes loading, by the host processor, the information regarding the storage device from the memory of the device without pinning a portion of the memory of the device.

Statement 71. An embodiment of the disclosure includes the method according to statement 60, wherein the information regarding the storage device includes at least one of a static information or a dynamic information.

Statement 72. An embodiment of the disclosure includes the method according to statement 71, wherein the static information includes at least one of an identity information or a feature information.

Statement 73. An embodiment of the disclosure includes the method according to statement 71, wherein the dynamic information includes runtime statistic information.

Statement 74. An embodiment of the disclosure includes the method according to statement 60, further comprising allocating, by a host processor, a portion of the memory of the device to store the information regarding the storage device.

Statement 75. An embodiment of the disclosure includes an article, comprising a non-transitory storage medium, the non-transitory storage medium having stored thereon instructions that, when executed by a machine, result in:
loading, by a device, information relating to a request from a memory of the device; and
executing the request on a data using a processor of the device,
wherein the data is stored on a storage device.

Statement 76. An embodiment of the disclosure includes the article according to statement 75, wherein the memory of the device includes a Compute Express Link (CXL) memory of the device.

Statement 77. An embodiment of the disclosure includes the article according to statement 76, wherein the CXL memory of the device includes a CXL type 2 memory of the device.

Statement 78. An embodiment of the disclosure includes the article according to statement 75, the non-transitory storage medium having stored thereon further instructions that, when executed by the machine, result in storing, by a host processor, the information relating to the request into the memory of the device.

Statement 79. An embodiment of the disclosure includes the article according to statement 78, wherein storing, by the host processor, the information relating to the request into the memory of the device includes storing, by a device driver executing on the host processor, the information relating to the request into the memory of the device.

Statement 80. An embodiment of the disclosure includes the article according to statement 78, wherein storing, by the host processor, the information relating to the request into the memory of the device includes storing, by the host processor, the information relating to the request into the memory of the device without using a Direct Memory Address (DMA) transfer.

Statement 81. An embodiment of the disclosure includes the article according to statement 78, wherein storing, by the host processor, the information relating to the request into the memory of the device includes storing, by the host processor, the information relating to the request into the memory of the device using a store request.

Statement 82. An embodiment of the disclosure includes the article according to statement 78, wherein storing, by the host processor, the information relating to the request into the memory of the device includes storing, by the host processor, the information relating to the request into the memory of the device without pinning a portion of the memory of the device.

Statement 83. An embodiment of the disclosure includes the article according to statement 75, wherein loading, by the device, the information relating to the request from the memory of the device includes loading, by the processor, the information relating to the request from the memory of the device.

Statement 84. An embodiment of the disclosure includes the article according to statement 83, wherein loading, by the processor, the information relating to the request from the memory of the device includes loading, by the processor, the information relating to the request from the memory of the device without using a DMA transfer.

Statement 85. An embodiment of the disclosure includes the article according to statement 83, wherein loading, by the processor, the information relating to the request from the memory of the device includes loading, by the processor, the information relating to the request from the memory of the device using a load request.

Statement 86. An embodiment of the disclosure includes the article according to statement 75, wherein the information relating to the request includes at least one of a submission queue, a completion queue, a packet structure including the request, or a payload structure.

Statement 87. An embodiment of the disclosure includes the article according to statement 86, wherein the information relating to the request further includes a kernel.

Statement 88. An embodiment of the disclosure includes the article according to statement 87, wherein the kernel includes a kernel binary.

Statement 89. An embodiment of the disclosure includes the article according to statement 88, the non-transitory storage medium having stored thereon further instructions that, when executed by the machine, result in storing, by a host processor, the kernel binary into a program slot in the memory of the device.

Statement 90. An embodiment of the disclosure includes the article according to statement 75, the non-transitory storage medium having stored thereon further instructions that, when executed by the machine, result in storing, by the device, a result of the request in the memory of the device.

Statement 91. An embodiment of the disclosure includes the article according to statement 90, wherein storing, by the device, the result of the request in the memory of the device includes storing, by the processor, the result of the request in the memory of the device.

Statement 92. An embodiment of the disclosure includes the article according to statement 91, wherein storing, by the processor, the result of the request in the memory of the device includes storing, by the processor, the result of the request in the memory of the device without using a Direct Memory Address (DMA) transfer.

Statement 93. An embodiment of the disclosure includes the article according to statement 91, wherein storing, by the processor, the result of the request in the memory of the device includes storing, by the processor, the result of the request in the memory of the device using a store request.

Statement 94. An embodiment of the disclosure includes the article according to statement 90, the non-transitory storage medium having stored thereon further instructions that, when executed by the machine, result in loading, by a host processor, the result of the request from the memory of the device.

Statement 95. An embodiment of the disclosure includes the article according to statement 94, wherein loading, by the host processor, the result of the request from the memory of the device includes loading, by the host processor, the result of the request from the memory of the device without using a DMA transfer.

Statement 96. An embodiment of the disclosure includes the article according to statement 94, wherein loading, by the host processor, the result of the request from the memory of the device includes loading, by the host processor, the result of the request from the memory of the device using a load request.

Statement 97. An embodiment of the disclosure includes the article according to statement 75, the non-transitory storage medium having stored thereon further instructions that, when executed by the machine, result in allocating, by a host processor, a portion of the memory of the device to store the information relating to the request.

Statement 98. An embodiment of the disclosure includes the article according to statement 75, wherein the device includes the storage device.

Statement 99. An embodiment of the disclosure includes an article, comprising a non-transitory storage medium, the non-transitory storage medium having stored thereon instructions that, when executed by a machine, result in:
determining, by a device, information regarding a storage device of the device; and
storing, by the device, the information regarding the storage device into a memory of the device.

Statement 100. An embodiment of the disclosure includes the article according to statement 99, wherein the memory of the device includes a Compute Express Link (CXL) memory of the device.

Statement 101. An embodiment of the disclosure includes the article according to statement 100, wherein the CXL memory of the device includes a CXL type 2 memory of the device.

Statement 102. An embodiment of the disclosure includes the article according to statement 99, wherein:
the method the non-transitory storage medium having stored thereon further instructions that, when executed by the machine, result in receiving, by the device, a request for the information regarding the storage device from a host processor; and
storing, by the device, the information regarding the storage device into a memory of the device includes storing, by the device, the information regarding the storage device into a memory of the device based at least part on the request for the information regarding the storage device received from the host processor.

Statement 103. An embodiment of the disclosure includes the article according to statement 99, wherein storing, by the device, the information regarding the storage device into the memory of the device includes storing, by the device, the information regarding the storage device into the memory of the device without using a DMA transfer.

Statement 104. An embodiment of the disclosure includes the article according to statement 99, wherein storing, by the device, the information regarding the storage device into the memory of the device includes storing, by the device, the information regarding the storage device into the memory of the device using a load request.

Statement 105. An embodiment of the disclosure includes the article according to statement 99, the non-transitory storage medium having stored thereon further instructions that, when executed by the machine, result in loading, by a host processor, the information regarding the storage device from the memory of the device.

Statement 106. An embodiment of the disclosure includes the article according to statement 105, wherein loading, by a host processor, the information regarding the storage device from the memory of the device includes loading, by a device driver executing on a host processor, the information regarding the storage device from the memory of the device.

Statement 107. An embodiment of the disclosure includes the article according to statement 105, wherein loading, by the host processor, the information regarding the storage device from the memory of the device includes loading, by the host processor, the information regarding the storage device from the memory of the device without using a Direct Memory Address (DMA) transfer.

Statement 108. An embodiment of the disclosure includes the article according to statement 105, wherein loading, by the host processor, the information regarding the storage device from the memory of the device includes loading, by the host processor, the information regarding the storage device from the memory of the device using a load request.

Statement 109. An embodiment of the disclosure includes the article according to statement 105, wherein loading, by the host processor, the information regarding the storage device from the memory of the device includes loading, by the host processor, the information regarding the storage device from the memory of the device without pinning a portion of the memory of the device.

Statement 110. An embodiment of the disclosure includes the article according to statement 99, wherein the information regarding the storage device includes at least one of a static information or a dynamic information.

Statement 111. An embodiment of the disclosure includes the article according to statement 110, wherein the static information includes at least one of an identity information or a feature information.

Statement 112. An embodiment of the disclosure includes the article according to statement 110, wherein the dynamic information includes runtime statistic information.

Statement 113. An embodiment of the disclosure includes the article according to statement 99, the non-transitory storage medium having stored thereon further instructions that, when executed by the machine, result in allocating, by a host processor, a portion of the memory of the device to store the information regarding the storage device.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A device, comprising:
a memory to store information relating to a request; and
a processor to process a data based at least in part on the information relating to the request,
wherein the data is stored on a storage device; and
wherein a host processor is configured to store the information relating to the request into the memory.

2. The device according to claim 1, wherein a device driver executing on the host processor is configured to store the information relating to the request into the memory.

3. The device according to claim 1, wherein the information relating to the request includes at least one of a submission queue, a completion queue, a packet structure including the request, or a payload structure.

4. The device according to claim 3, wherein the information relating to the request further includes a kernel.

5. The device according to claim 1, wherein the memory is configured to store a result of the request.

6. The device according to claim 1, wherein the host processor is configured to allocate a portion of the memory to store the information relating to the request.

7. The device according to claim 1, further comprising the storage device.

8. A device, comprising:
a storage device; and
a memory to store information regarding the storage device; and
wherein the storage device is configured to store the information regarding the storage device into the memory.

9. The device according to claim 8, wherein a device driver executing on the host processor is configured to load the information regarding the storage device from the memory.

10. The device according to claim 8, wherein the device is configured to store the information regarding the storage device into the memory.

11. The device according to claim 8, wherein the information regarding the storage device includes at least one of a static information or a dynamic information.

12. The device according to claim 11, wherein the dynamic information includes runtime statistic information.

13. A method, comprising:
loading, by a device, information relating to a request from a memory of the device; and
executing the request on a data using a processor of the device,
wherein the data is stored on a storage device.

14. The method according to claim 13, further comprising storing, by a host processor, the information relating to the request into the memory of the device.

15. The method according to claim 14, wherein storing, by the host processor, the information relating to the request into the memory of the device includes storing, by a device driver executing on the host processor, the information relating to the request into the memory of the device.

16. The method according to claim 13, wherein the information relating to the request includes at least one of a submission queue, a completion queue, a packet structure including the request, or a payload structure.

17. The method according to claim 16, wherein the information relating to the request further includes a kernel.

18. The method according to claim 13, further comprising storing, by the device, a result of the request in the memory of the device.

19. The method according to claim 18, wherein storing, by the device, the result of the request in the memory of the device includes storing, by the processor, the result of the request in the memory of the device.

20. The method according to claim 13, further comprising allocating, by a host processor, a portion of the memory of the device to store the information relating to the request.
